(19) United States
(12) Patent Application Publication
(10) Pub. No.: US 2013/0154423 A1
(43) Pub. Date: Jun. 20, 2013

(54) AXIAL FLUX ALTERNATOR WITH ONE OR MORE FLUX AUGMENTATION RINGS

(71) Applicant: Steven C. Hench, Annapolis, MD (US)

(72) Inventor: Steven C. Hench, Annapolis, MD (US)

(21) Appl. No.: 13/715,572

(22) Filed: Dec. 14, 2012

Related U.S. Application Data
(60) Provisional application No. 61/570,782, filed on Dec. 14, 2011.

(51) Int. Cl. H02K 1/27; H02K 16/00

(52) U.S. Cl. CPC H02K 1/27; H02K 16/00
USPC 310/114; 310/156.07

(57) ABSTRACT

An axial flux alternator may comprise one or more rotors comprising magnets, one or more stators comprising coils, one or more flux augmentation rings comprising a ferrous material, wherein the magnets, coils, and at least a portion of the flux augmentation rings are arranged at a substantially similar radial distance from the common axis, and wherein the rotors are rotatable about the common axis. Another axial flux alternator may comprise one or more flux augmentation rings, magnets configured to travel along a predetermined path, and coils disposed between the flux augmentation ring and the predetermined path, wherein the flux augmentation ring is configured to draw a magnetic flux field from the magnets that crosses the conductive coils thereby creating a voltage potential therein. An axial flux alternator system may comprise one or more rotors, flux augmentation rings, and stators, an input source, and an output load.

### CROSS-REFERENCE TO RELATED APPLICATIONS

This application claims priority to U.S. Provisional Patent Application No. 61/570,782, entitled AXIAL FLUX ALTERNATOR WITH ONE OR MORE FLUX AUGMENTATION RINGS, filed Dec. 14, 2011, which is hereby incorporated by reference for all purposes.

### FIELD OF THE INVENTION

The present disclosure generally relates to an axial flux alternator, and more particularly to a flux augmentation ring that may enhance alternator efficiency at an efficient cost.

### BACKGROUND

Axial flux alternators convert mechanical energy into electrical energy through the use of magnetic inductance principles. Mechanical energy, generated by a wind turbine for example, is transferred to an input shaft, which spins a rotor(s) containing an array of permanent magnets. Rotation of the magnets causes alternating magnetic fields to pass over coils of wire affixed to stators, thereby creating a voltage potential in the wire through magnetic inductance. The electricity generated by the axial flux alternator is then used by electronic devices or is stored for later use.

Axial flux alternators share some common limitations. Power efficiency is, in part, dependent upon the strength of magnetic flux fields contained therein. Many of these devices rely on a large number of magnets (often arranged on multiple rotors) to create strong magnetic flux fields to increase power efficiency. However, a significant increase in the cost of rare-earth magnets is quickly making these arrangements less cost efficient, especially for larger designs. Moreover, attractive forces between these magnets can create undesirable axial warping forces on magnet rotors. Additionally, many axial flux alternators experience cogging forces that limit low torque applications. Furthermore, designs using ferrous stator materials often experience eddy current back forces that result in energy loss through heat dissipation and magnetic drag on the rotors. Still further, some components of axial flux alternators may suffer from warping caused by electromagnetic forces generated between rotors and stators therein. Additionally, warping forces may be generated in designs that use only one side of magnets, often mounted on a ferritic substrate, to help vector more field strength in the direction of stator coils. Warping can become increasingly problematic as the diameter of the alternator increases. It can be costly to strengthen these components to resist warping forces.

### SUMMARY

The present disclosure is directed to an axial flux alternator that may comprise one or more rotors, each rotor comprising one or more magnets; one or more stators, each stator comprising one or more coils of electrically conductive material; one or more flux augmentation rings comprising a ferrous material; wherein the one or more rotors, one or more stators, and one or more flux augmentation rings may be arranged about a common axis with predetermined spacing between each; wherein the one or more magnets, one or more conductive coils, and at least a portion of the one or more flux augmentation rings may be arranged at a substantially similar radial distance from the common axis; and wherein the one or more rotors may be rotatable about the common axis.

In various embodiments, the one or more rotors may comprise non-ferrous materials. In an embodiment, the one or more magnets may be embedded within the one or more rotors. In another embodiment, the one or more magnets may be arranged in a pattern with alternating polarities on a given rotor.

In various embodiments, the one or more stators may comprise non-ferrous materials. In various embodiments, the one or more stators may comprise dielectric materials. In an embodiment, the dielectric materials may be arranged in multiple layers. In another embodiment, the one or more stators may comprise materials configured to reduce the build up of Lenz force therein.

In various embodiments, the one or more flux augmentation rings may comprise steel material. In an embodiment, a given flux augmentation ring may be rotationally coupled with an adjacent rotor.

In various embodiments, the one or more stators may comprise slots to facilitate winding of the coils. In an embodiment, adjacent slots may have necked regions arranged in alternating orientations. In another embodiment, the one or more coils may be wound about the slots in an over/under pattern configured to minimize warping forces on the one or more stators. In yet another embodiment, at least one of the one or more stators may comprise coils on opposite surfaces of the stator.

In an embodiment, at least one of the one or more stators may be disposed between a rotor and a flux augmentation ring. In another embodiment, axial flux alternator may have a 2:1 or greater ratio of magnets to coils.

In another aspect, the present disclosure is directed to an axial flux alternator that may comprise one or more flux augmentation rings comprising a ferrous material; one or more magnets configured to travel along a predetermined path, at least a portion of the path being offset from and aligned substantially parallel to at least a portion of the flux augmentation ring; one or more coils of electrically conductive material disposed between the flux augmentation ring and the predetermined path; wherein the flux augmentation ring may be configured to draw a magnetic flux field from the one or more magnets; and wherein as the one or more magnets travel along the predetermined path, the magnetic flux field crosses the one or more conductive coils thereby creating a voltage potential therein.

In various embodiments, the one or more magnets and correspondingly aligned portions of the one or more flux augmentation rings move together. In an embodiment, the movement of the one or more magnets and correspondingly aligned portions of the one or more flux augmentation rings substantially eliminates cogging.

In another aspect, the present disclosure is directed to an axial flux alternator that may comprise one or more rotors rotatable about an axis, each rotor comprising one or more magnets; one or more flux augmentation rings comprising a ferrous material, each flux augmentation ring being substantially centered about the axis and offset from an adjacent rotor; one or more stators centered about the axis, each stator being disposed between one of the one or more rotors and one of the one or more flux augmentation rings, each stator comprising one or more electrically conductive coils; wherein the one or more magnets, one or more conductive coils, and at least a portion of the one or more flux augmentation rings may be arranged at a substantially similar radial distance from the common axis; an input source that may be capable of transferring mechanical energy to the one or more rotors; and an output source that may be capable of receiving electrical energy from the one or more coils; wherein the input source may drive rotation of the one or more rotors, providing for magnetic fields spanning between the one or more magnets and the one or more flux augmentation rings to cross the one or more conductive coils, thereby generating electrical energy that is transferred to the output source.

In an embodiment, the one or more coils may be connected in series for single-phase power takeoff. In another embodiment, subsets of the one or more coils may be wired in series for multi-phase power takeoff.

### BRIEF DESCRIPTION OF THE DRAWINGS

For a more complete understanding of this disclosure, reference is now made to the following description, taken in conjunction with the accompanying drawings, in which:

FIG. 1 depicts a perspective view of an axial flux alternator according to an embodiment of the present disclosure;

FIG. 2A depicts a perspective view of a rotor that may be used in an axial flux alternator according to an embodiment of the present disclosure;

FIG. 2B depicts a side view of a rotor and magnet arrangement that may be used in an axial flux alternator according to an embodiment of the present disclosure;

FIG. 3A depicts a perspective view of a stator comprising an array of wire coils that may be used in an axial flux alternator according to an embodiment of the present disclosure;

FIG. 3B depicts a top view of a stator comprising winding slots according to an embodiment of the present disclosure;

FIG. 4 depicts a partial side cutaway view of a traditional axial flux alternator;

FIG. 5 depicts a perspective view of a flux augmentation ring that may be used in an axial flux alternator according to an embodiment of the present disclosure;

FIG. 6 depicts an exploded view of an axial flux alternator according to an embodiment of the present disclosure;

FIG. 7A depicts a partial side cutaway view of an axial flux alternator according to an embodiment of the present disclosure;

FIG. 7B depicts a schematic illustration of possible magnetic flux paths drawn through elements of an axial flux alternator according to an embodiment of the present disclosure; and

FIG. 8 depicts a partial side cutaway view of a possible stacked-type arrangement of multiple axial flux alternators according to an embodiment of the present disclosure.

### DETAILED DESCRIPTION

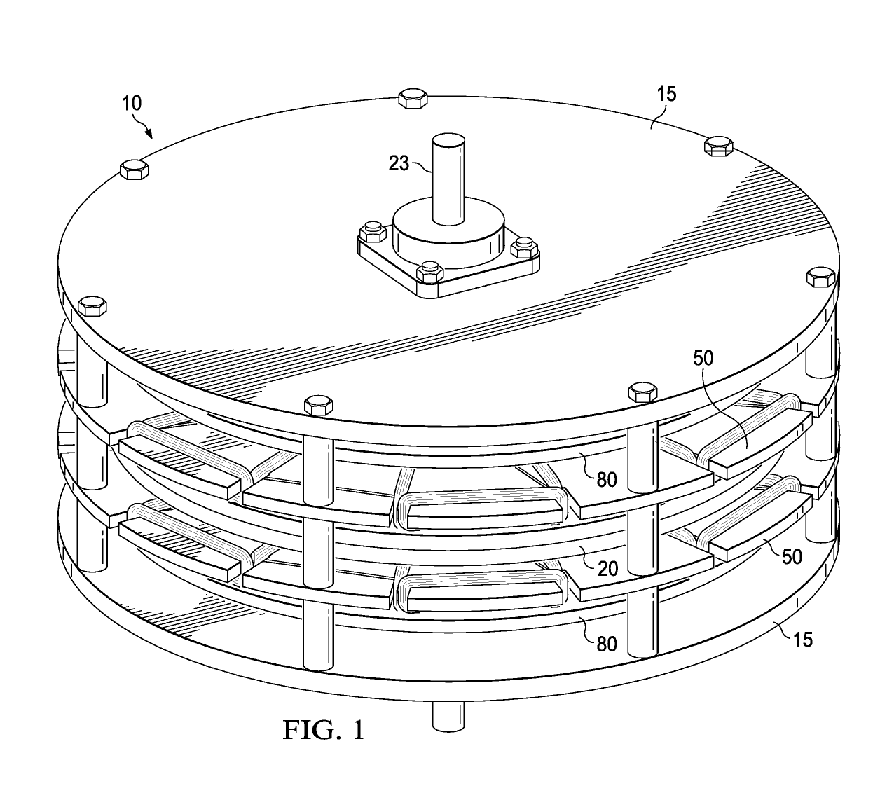

Referring to FIG. 1, axial flux alternator 10 may generally comprise one or more rotors 20, stators 50, and flux augmentation rings 80. In various embodiments, axial flux alternator 10 may comprise housing 15 and/or shaft 23. Axial flux alternator 10 may be connected to an input source of mechanical energy, such as a wind turbine or wave buoy, to facilitate conversion of that mechanical energy into electrical energy. Axial flux alternator may also be connected to an output load, such as a battery or capacitor, and transmit electrical energy thereto for use or storage.

### Rotors & Magnets

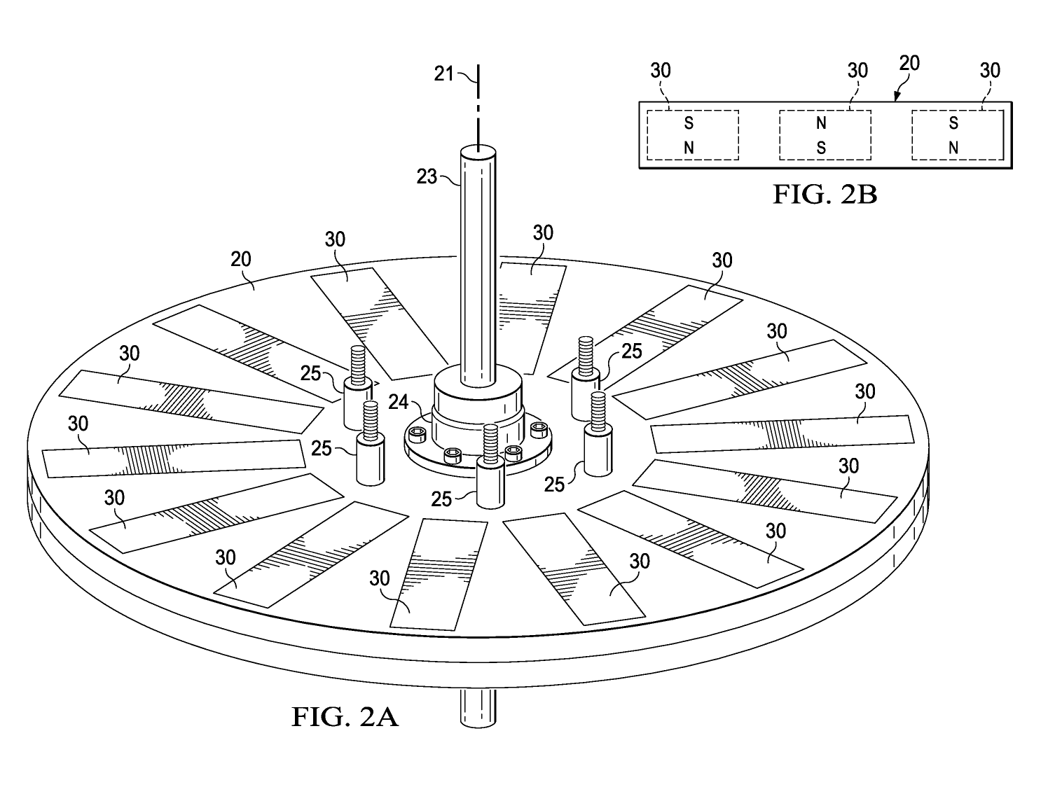

FIG. 2A depicts a rotor 20 that may be used in an axial flux alternator 10 according to the present disclosure. In one embodiment, axial flux alternator 10 may include a plurality of rotors 20. Rotor 20 may take the form of any suitable geometric shape. For instance, in the embodiment depicted in FIG. 2A, rotor 20 may be disk shaped since shapes with generally equal radial distribution of mass may improve rotational stability about a central axis 21. In one embodiment, an axial thickness of rotor 20 may be minimized, so as to be substantially equal to or less than an axial thickness of magnets 30 (later described) while still maintaining sufficient structural integrity. In another embodiment, a radial span of rotor 20 may vary depending on the application for which axial flux alternator 10 is used. Moreover, in an axial flux alternator 10 having two or more rotors 20, the shape and dimensions of each rotor 20 is a matter of design choice—depending upon the desired operational characteristics, the shapes and dimensions may vary, or the shapes and dimensions may be generally identical.

While rotors 20 may be made of any suitable material, they are preferably constructed of non-ferrous materials. Unlike ferrous rotors—which may pull magnetic flux radially from magnets 30, thereby inhibiting axial flux projection across stator coils 60—non-ferrous rotors would not. Additionally, rotors 20 may be made lighter by using non-ferrous materials. Other suitable materials for rotors 20 will be readily apparent to those skilled in the art. In one embodiment, rotors 20 may be fixedly connected to a shaft or similar structure 23 that is rotatable about central axis 21. Rotors 20 may be centered about central axis 21 and may be connected to a shaft 23 by flange 24 or any other suitable mechanism, including but not limited to friction, adhesive, welding, pins, or clamps. Shaft 23, and rotors 20 connected thereto, may be rotated by any mechanism, including but not limited to any device that extracts energy from its surroundings. Those of ordinary skill in the art will recognize that, in accordance with the present disclosure, rotors 20 may be fixedly connected to any alternative support structure using any mechanism so long as rotation of rotors 20 about central axis 21 may be achieved.

Rotor 20 may comprise one or more magnets 30. Magnets 30 may be any material capable of carrying a permanent magnetic charge. Magnets comprised of alloys of rare earth metals such as neodymium (NdFeB) and/or samarium cobalt (SmCo) are frequently used in the art, as are non rare earth permanent magnets such as those composed of ferrite. Other suitable magnetic materials will be readily apparent to those skilled in the art. Magnets 30 may be of any suitable shape and size, including but not limited to circular, rectangular, and wedge shapes. One or more magnets 30 may be mounted to each rotor 20, and may be distributed with substantially equal spacing and in a substantially symmetric pattern to maintain favorable balance as rotor 20 spins about central axis 21. In one embodiment, magnets 30 may be affixed to an outer surface of rotor 20. In another embodiment, magnets 30 may be embedded in rotors 20. Such a construction would allow both sides of magnets 30 to project substantially similar axial flux fields in opposite axial directions, thus enabling a single rotor 20 to project magnetic flux axially across stators 50 located on opposite sides of rotor 20. This embodiment has the added benefit of balancing both axial and radial loads on the rotor. Embedding magnets 20 may also avoid radial displacement of magnets 20 due to centrifugal forces by enabling the magnets 20 to be held in place by the tensile strength of the rotor material. Embedding magnets 20 also helps to balance magnetic forces pulling axially on each side of the rotor. A thin layer of adhesive and dielectric material, such as fiberglass, carbon fiber, aluminum, titanium, or other suitable non-conductive substance may cover the magnets 30. Circular patterns of magnets 30 may be used, but the present disclosure should be understood to encompass other suitable distributions.

Referring now to FIG. 2B, magnets 30 may be arranged with alternating polarities on a given rotor (N-S-N-S). This alternating polarity helps to ensure that, as rotor 20 spins, a given point in space near the spinning magnets 30 will experience alternating magnetic fields. These alternating magnetic fields may be used to induce a current and voltage in coil 60 of axial flux alternator 10, thereby converting mechanical energy associated with rotation of rotor 20 into electrical energy. Shape, size, and number of magnets 30 may vary with various design constraints, such as overall physical size of axial flux alternator 10 and the desired electrical output of the device. In one embodiment, magnets 30 are of substantially similar size and shape and are arranged in substantially similar geometric patterns on each rotor 20.

### Stators & Coils

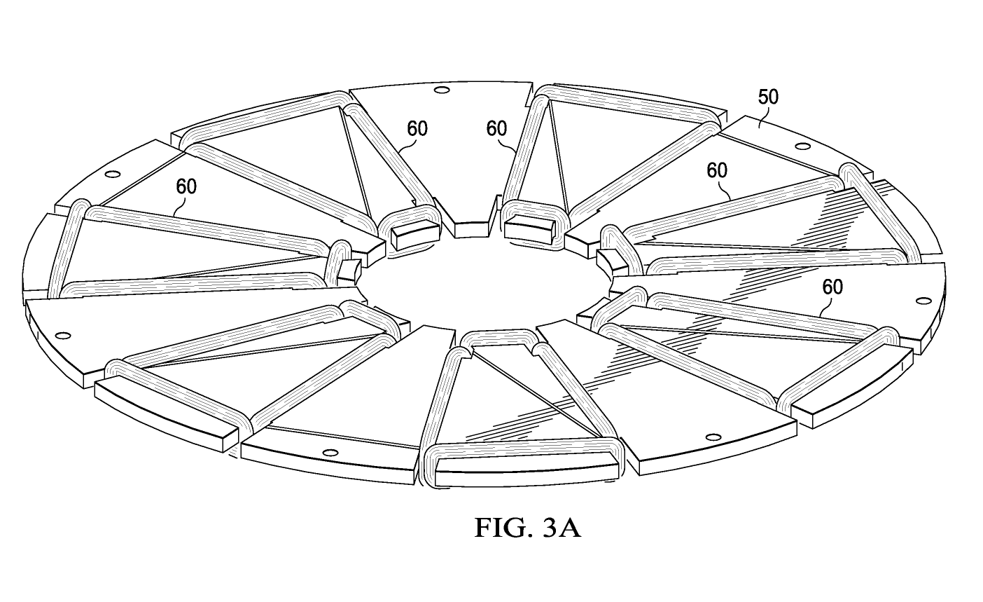

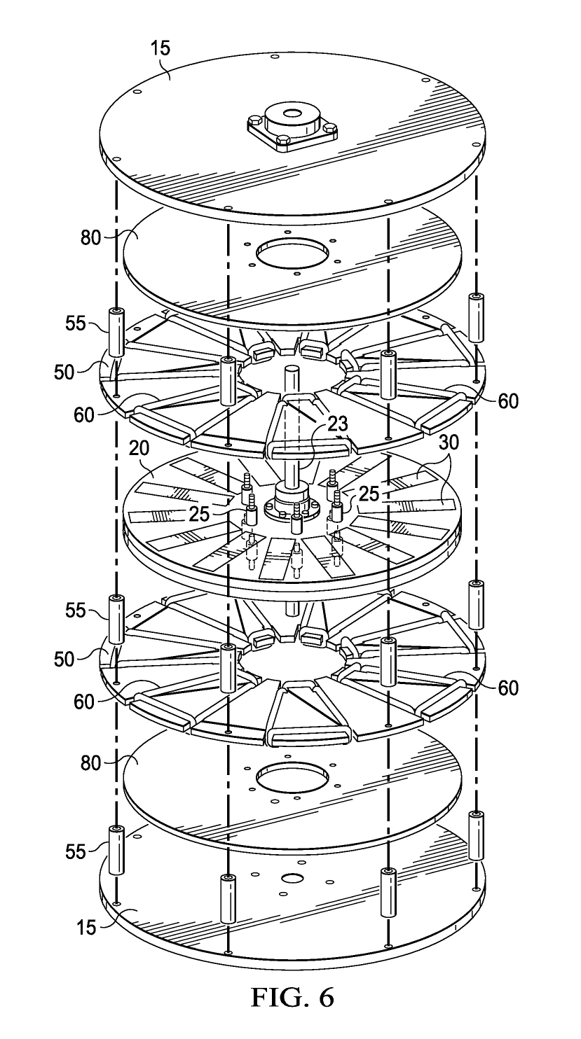

Referring now to FIGS. 3A and 3B, FIG. 3A depicts a stator 50 that may be used in an axial flux alternator 10 according to the present disclosure. In one embodiment, axial flux alternator 10 may include a plurality of stators 50. Stator 50 may take the form of any suitable geometric shape. In one embodiment, however, the shape of stator 50 may substantially match the shape of rotor 20. In an embodiment, an axial thickness of stator 50 may be minimized, so as to be substantially equal to or less than an axial thickness of coils 60 while still maintaining sufficient structural integrity. In another embodiment, a radial span of stator 50 may vary depending on the application for which axial flux alternator 10 is used. Although not limiting the scope of the present disclosure, a radial span of stator 50 is typically equal to or greater than a span of rotor 20 in a particular axial flux alternator 10. In an embodiment, stators 50 may have a radial span that exceeds that of rotor 20, thereby providing for spacers 55 to couple stators 50 and provide desired axial spacing between them, while rotor 20 may spin without interference as shown in FIG. 6. Spacers 55 may be constructed of any suitable material, though non-ferrous materials are preferred to avoid distorting the flux pattern away from coils 60. One having ordinary skill in the art will recognize that the previously described embodiment is but one of many possible configurations suitable for supporting stators 50 while providing for rotor 20 to rotate without interference; therefore it should be recognized that the present disclosure should not be limited to this specific embodiment. Moreover, in an axial flux alternator 10 having two or more stators 50, the shape and dimensions of each stator 50 is a matter of design choice—depending upon the desired operational characteristics, the shapes and dimensions may vary, or the shapes and dimensions may be generally identical.

Preferably, stators 50 may be made of any non-ferrous material. Stators 50 comprised of non-ferrous materials may avoid heat losses and rotational drag commonly associated with ferrous stator cores. Stators 50 made of ferrous material often experience eddy current back-force, or Lenz force, due to the buildup of opposing magnetic fields within the ferrous material. This back-force can lead to energy loss, both through heat dissipation and the drag on nearby rotors 20. In various embodiments, stators 50 are made of dielectric materials. In an embodiment, stators 50 comprise multiple thin layers of dielectric materials including, but not limited to glass-reinforced plastics, such as Garolite. Each may be insulated with a thin layer of dielectric material, such as varnish. An advantage of such a construction is that Lenz forces do not build up as much in thin layers. In another embodiment, stainless steel stator substrate, such as high-silicon steel or austenitic (non-magnetic) stainless steel, may be used. Other suitable materials for stators 50 will be readily apparent to those skilled in the art including, but not limited to wood, nylon, and ceramics. In one embodiment, stators 50 may extend from and/or be fixedly connected to an external housing by welding, mounting brackets, friction fit, or any other suitable attachment mechanism. One skilled in the art will recognize that the particular structure used to support the various components comprising axial flux alternator is not limited by the aforementioned embodiment. Any suitable support structure that allows for alignment and relative rotation of the various components of axial flux alternator 10 according to the present disclosure is recognized as being included herein.

Stators 50 may comprise one or more wire coils 60. Wire coils 60 may be used, in combination with the rotating magnetic fields created by rotors 20, to generate electrical energy. Due to the alternating radial arrangement of the magnet poles on rotor 20, the magnetic field flips each time a magnet 30 passes over a coil 60. The more rapidly the field flips, the more voltage is created. Coils 60 may include any type of conductive wire, such as copper, twisted into a series of concentric loops. FIG. 3 depicts a circular pattern of coils 60 on stator 50; however, one of ordinary skill in the art will understand that any other suitable arrangement or configuration of coils 60 on stator 50 may be used. In one embodiment, coils 60 may be affixed to an outer surface of stator 50. In another embodiment, coils 60 may be embedded (in whole or in part) within stator 50. A thin epoxy, carbon fiber, or other suitable non-conductive substance may cover the coils 60 to hold them in place. The configuration of coils 60 may be substantially axially aligned with a rotational path of magnets 30 affixed to a spinning rotor 20. Electrical energy may be captured as a result of a voltage potential induced by alternating magnetic fields passing across a given stator coil.

Coils 60 may be coupled with stator 50 in any suitable manner. Referring to FIG. 3B, in various embodiments, stators 50 may comprise inner slots 52 and outer slots 54 or other mechanisms to facilitate the winding of coils 60. In an embodiment, inner slots 52 may comprise a necked-down region 52a to prevent the wire from slipping off during the winding process. Necking orientation may alternate over adjacent inner slots 52; stated otherwise, necked regions 52a may face away from each other in pairs. This “reverse-necking” may prevent wire of coils 60 from “jumping off” stator 50, as may be the case if necked regions 52a pointed towards a common center. A straight region 52b may be vectored towards opposing outer slots 54. Coils 60 may be wound about slots 52 and 54 in any suitable pattern. In an embodiment, coils 60 may be wound about stator 50 in a manner configured to avoid applying cumulative mechanical loads on stator 50 that could result in it warping over time. In one such embodiment, coils 60 may be wound in an over/under pattern around stator 50, winding each back-to-back coil 60 first on one side for a number of turns, then on the other side of the stator for a number of turns. In another embodiment, winding may be performed on one side of stator 50 all around, and then on the second side of stator 50. Such an embodiment has the potential to (but doesn't necessarily) impart mechanical loads to stator 50 that may cause warping, however.

The number of coils 60 used in axial flux alternator 10 is a matter of design choice, as is the size, length, and gauge of the wire used for coils 60. For instance, various design constraints such as overall physical size of axial flux alternator 10 and the desired electrical output of axial flux alternator 10 may affect the number, size, length, and gauge of wire coils 60. Typically, the greater the number of loops contained in a coil 60, the more voltage may be captured. Higher gauge wire can typically carry more current than similar wire of a lower gauge; however, higher gauge wire also typically occupies additional space than similar wire of a lower gauge, thus potentially limiting the number of loops contained in a coil 60 of a given size.

Coils 60 may be formed of wire enshrouded by a non-conductive insulator. Any type of non-conductive insulator is suitable, but one embodiment may utilize thin non-conductive enamel that helps to insulate each loop in coil 60 from one another, but does not occupy the amount of space required by a traditional rubber insulator. One of skill in the art will recognize that a desired balance between wire gauge (∝ current) and number of loops (∝ voltage) may be selected depending on the application for which axial flux alternator 10 will be used. In one embodiment, coils 60 are of substantially similar dimensions, comprise substantially similar gauge wire and number of loops, and are arranged in substantially similar geometric patterns on each stator 50.

One of ordinary skill will further recognize that a desired ratio of magnets 30 to coils 60 used in axial flux alternator 10 may be selected based on several design factors, including but not limited to the desirability of phasing. Moreover, depending on the application, all coils 60 on a given stator 50 may be connected in series, effecting “single-phase” power-takeoff; or, subsets of coils 60 may be wired in series to effect “multi-phase” power-takeoff. In single-phase operation, power from all coils 60 is collected simultaneously. While this configuration has the advantage of simplicity, such phasing may yield a large pulse of power that may, in turn, result in vibrations. Unless mitigating measures are taken, these vibrations could potentially damage or decrease performance of axial flux alternator 10 and any turbine connected thereto. In multi-phase operation, coils 60 may be wired in series in smaller subgroups. While one subgroup produces peak power, the other two may be declining in power or at zero power. In this configuration, overall power take-off may be substantially equivalent to that of single-phase operation, large pulses may be avoided and smoother power collection may occur. In an embodiment, multi-phase operation may be achieved by running individual stators in single-phase power-takeoff. In various embodiments, axial flux alternator 10 may comprise two magnets 30 per coil 60, or greater. In an embodiment, axial flux alternator 10 may comprise a 4:1 ratio of magnets 30 per coil 60, or greater. In single-phase configurations, in an embodiment magnets 30 may align with opposite sides of each coil, thereby maximizing the flux sine wave. One of ordinary skill in the art will understand that design choices of this nature do not affect the scope of the present disclosure.

### Traditional Axial Flux Alternators

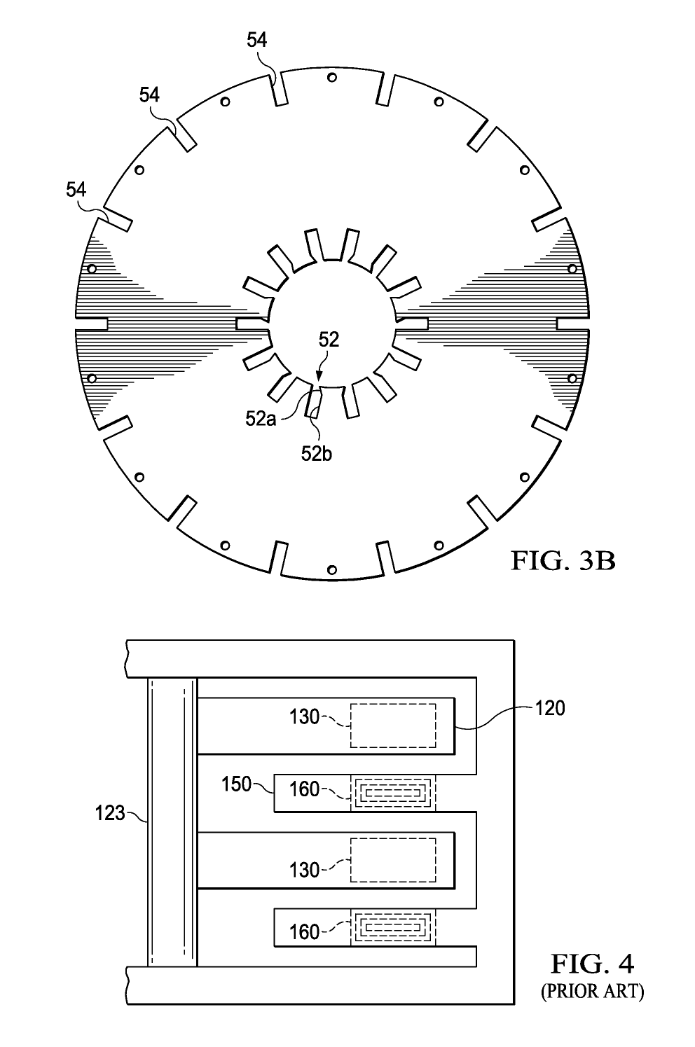

Axial flux alternators typically feature alternating arrangements of rotors and stators as shown in FIG. 4. As a rotor spins, magnets coupled thereto may pass over wire coils on the stators, inducing a voltage potential therein. These magnetic fields may be concentrated between sets of opposite-polarity magnets on adjacent rotors if the rotors are arranged sufficiently close to one another, as the intensity of a magnetic field increases closer to magnets. Axial alignment and close proximity of magnets on adjacent rotors likely results in larger voltage induction in the stator coils. While this arrangement may increase the efficiency of axial flux alternator 10, it may also increase the number of magnets necessary to construct axial flux alternator 10. Since the magnets constitute a substantial portion of the cost associated with axial flux alternator 10, especially considering the recent significant increases in costs for rare earth raw materials, the use of additional magnets may not be desirable from a cost-benefit analysis.

### Flux Augmentation Ring

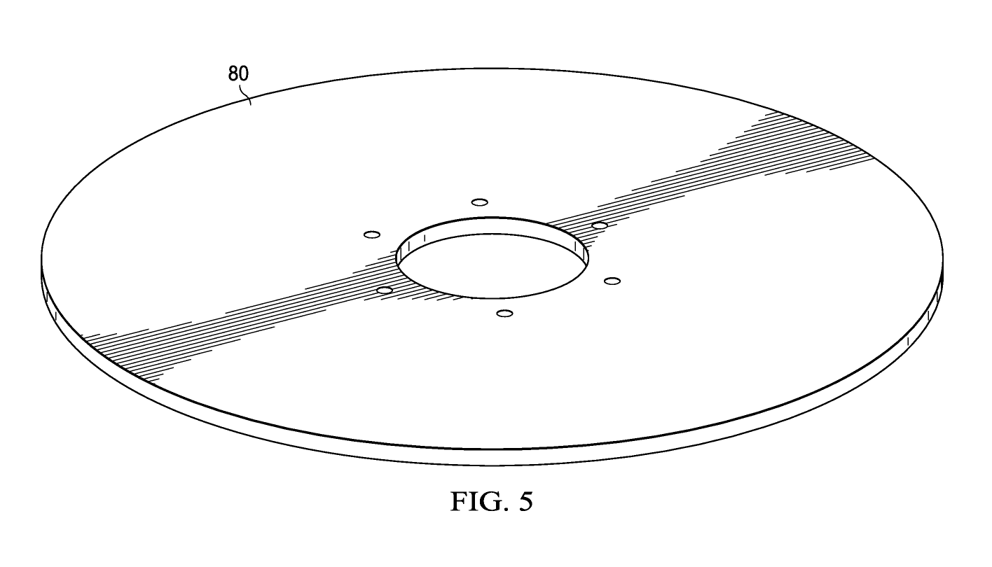

Referring now to FIGS. 5 and 6, axial flux alternator 10 may comprise one or more flux augmentation rings 80. Flux augmentation ring 80 may be constructed of any ferrous material and have sufficient strength to resist deflection under applied magnetic forces. In an embodiment, flux augmentation ring 80 may be comprised of steel. Unlike traditional axial flux alternators known in the art, in which magnetic fields are concentrated between sets of magnets on adjacent rotors, axial flux alternator 10 may comprise magnetic fields that are concentrated between magnets 30 on rotor 20 and an adjacent flux augmentation ring 80. Flux augmentation ring 80 may draw magnetic flux from magnets 30, thereby concentrating and intensifying the field across coils 60. This results in increased efficiency and power output for a lower cost of construction, as using a flux augmentation ring 80 composed of ferrous steel is generally less expensive than using another rotor containing rare earth magnets to achieve a similar effect. Referring to FIG. 6, in one embodiment, flux augmentation ring 80 may be fixedly attached to rotor 20 and oriented parallel to and in axial alignment with magnets 30. Supports 25 may couple flux augmentation ring 80 and rotor 20, providing for coupled rotation while avoiding interference with an intervening stator 50. An advantage of coupling the rotation of flux augmentation ring 80 and rotor 20 is the elimination of cogging, or “stiction”, within axial flux alternator 10. In this embodiment, when rotor 20 rotates, flux augmentation ring 80 rotates in unison. Because these parts do not experience rotational movement relative to one another, magnetic forces between them will not resist either's rotation. The resulting decrease in startup torque of this embodiment allows axial flux alternator to be effectively coupled with low torque input devices. In another embodiment, flux augmentation ring 80 may remain stationary by mounting it to an outer housing or other suitable structure (as opposed to being fixed to and rotatable with rotor 20). In yet another embodiment (not shown), more than one flux augmentation ring 80 may be fixedly attached to each rotor 20. A desired axial distance between rotor 20 and flux augmentation ring 80 may depend upon the thickness of stator 50 and the strength of magnets 30. The larger and more powerful magnets 30, the farther their flux fields extend naturally, and hence they can be spaced farther from flux augmentation rings 80 and still produce a similar effect. Greater flux enables more axial space for stator 50 and more volume for coils 60, thereby enabling increased power density. One having ordinary skill in the art will recognize that a variety of support structures and mechanisms may be used to provide for the arrangements of rotor 20, stators 50, and flux augmentation rings 80 described herein. It should be recognized that the present disclosure should not be limited to the aforementioned embodiments.

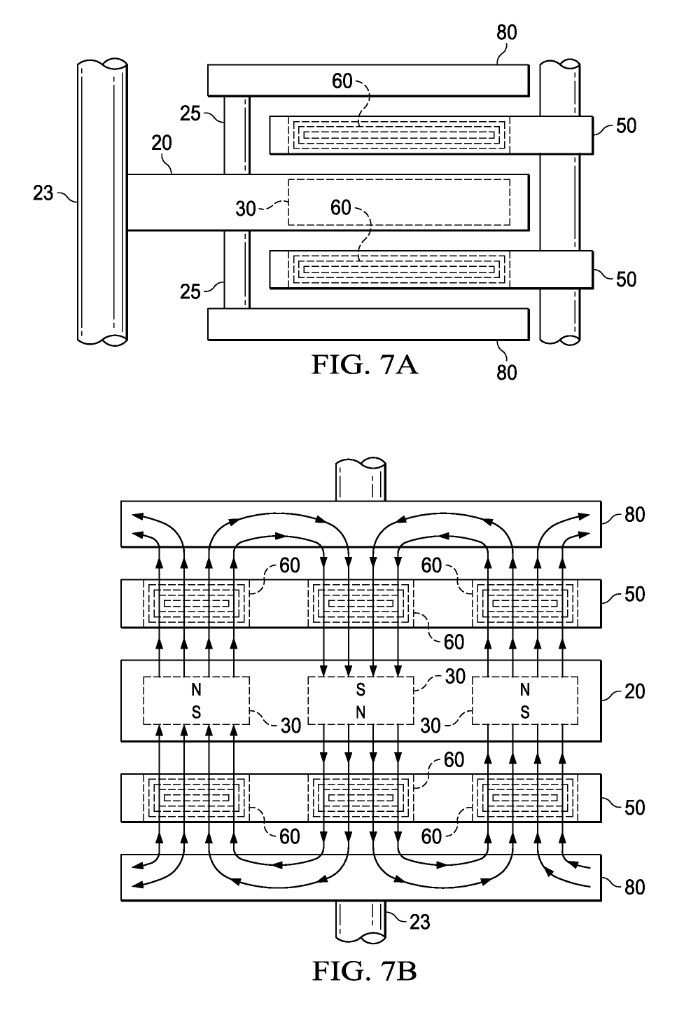

FIG. 7A depicts a partial side cutaway view of one embodiment of an axial flux alternator 10 according to the present disclosure. In the embodiment depicted, rotors 20, stators 50, and flux augmentation rings 80 are situated in relatively close axial proximity to one another, while maintaining tolerance for deviations in alignment when certain components are rotated. According to the present embodiment, flux augmentation ring 80, by nature of its ferrous properties, draws the magnetic flux field of axially aligned magnets 30, substantially concentrating said field across intervening stators coils 60, as shown in FIG. 7B. The overall arrangement of axial flux alternator 10 results in an increase in magnetic field strength on the order of 2:1, thereby raising the voltage through a given stator coil 60 by 2:1. By Ohm's Law, this in turn results in an overall power output increase of 4:1. By employing flux augmentation rings 80 to achieve these efficiencies rather than relatively expensive magnets, a large cost savings is achieved, particularly for larger designs.

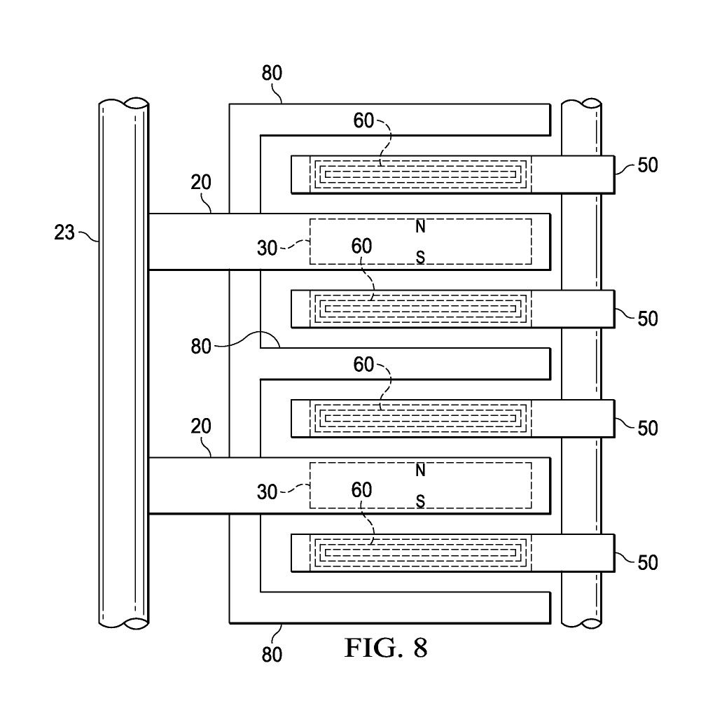

Referring now to FIG. 8, axial flux alternator 10 may comprise any reasonable numerical combination of rotors 20, stators 50, and flux augmentation rings 80 according to the present disclosure. Multiple axial flux alternators 10 may be combined in a stacked-type configuration along central axis 21. When multiple rotors 20 are employed, magnets 30 and rotors 20 may be arranged such that opposite poles face each other when viewed axially (N-S-N-S). The magnetic field may therefore be concentrated within a gap spanning between each set of magnets 30, thus helping to improve the efficiency of axial flux alternator 10.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An axial flux alternator comprising:
one or more rotors, each rotor comprising one or more magnets;
one or more stators, each stator comprising one or more coils of electrically conductive material;
one or more flux augmentation rings comprising a ferrous material;
wherein the one or more rotors, one or more stators, and one or more flux augmentation rings are arranged about a common axis with predetermined spacing between each;
wherein the one or more magnets, one or more conductive coils, and at least a portion of the one or more flux augmentation rings are arranged at a substantially similar radial distance from the common axis; and
wherein the one or more rotors are rotatable about the common axis.

2. The axial flux alternator of claim 1, wherein the one or more rotors comprise non-ferrous materials.

3. The axial flux alternator of claim 1, wherein the one or more magnets are embedded within the one or more rotors.

4. The axial flux alternator of claim 1, wherein the one or more magnets are arranged in a pattern with alternating polarities on a given rotor.

5. The axial flux alternator of claim 1, wherein the one or more stators comprise non-ferrous materials.

6. The axial flux alternator of claim 1, wherein the one or more stators comprise dielectric materials.

7. The axial flux alternator of claim 6, wherein the dielectric materials are arranged in multiple layers.

8. The axial flux alternator of claim 1, wherein the one or more stators comprise materials configured to reduce the build up of Lenz force therein.

9. The axial flux alternator of claim 1, wherein the one or more flux augmentation rings comprise steel material.

10. The axial flux alternator of claim 1, wherein a given flux augmentation ring is rotationally coupled with an adjacent rotor.

11. The axial flux alternator of claim 1, wherein the one or more stators comprise slots to facilitate winding of the coils.

12. The axial flux alternator of claim 11, wherein adjacent slots have necked regions arranged in alternating orientations.

13. The axial flux alternator of claim 11, wherein the one or more coils are wound about the slots in an over/under pattern configured to minimize warping forces on the one or more stators.

14. The axial flux alternator of claim 1, wherein at least one of the one or more stators comprises coils on opposite surfaces of the stator.

15. The axial flux alternator of claim 1, wherein at least one of the one or more stators is disposed between a rotor and a flux augmentation ring.

16. The axial flux alternator of claim 1, having a ratio of magnets to coils greater than or equal to 2:1.

17. An axial flux alternator comprising:
one or more flux augmentation rings comprising a ferrous material;
one or more magnets configured to travel along a predetermined path, at least a portion of the path being offset from and aligned substantially parallel to at least a portion of the flux augmentation ring;
one or more coils of electrically conductive material disposed between the flux augmentation ring and the predetermined path;
wherein the flux augmentation ring is configured to draw a magnetic flux field from the one or more magnets; and
wherein as the one or more magnets travel along the predetermined path, the magnetic flux field crosses the one or more conductive coils thereby creating a voltage potential therein.

18. The axial flux alternator of claim 17, wherein the one or more magnets and correspondingly aligned portions of the one or more flux augmentation rings move together.

19. The axial flux alternator of claim 18, wherein the movement of the one or more magnets and correspondingly aligned portions of the one or more flux augmentation rings substantially eliminates cogging.

20. An axial flux alternator system comprising:
one or more rotors rotatable about an axis, each rotor comprising one or more magnets;
one or more flux augmentation rings comprising a ferrous material, each flux augmentation ring being substantially centered about the axis and offset from an adjacent rotor;
one or more stators centered about the axis, each stator being disposed between one of the one or more rotors and one of the one or more flux augmentation rings, each stator comprising one or more electrically conductive coils;
wherein the one or more magnets, one or more conductive coils, and at least a portion of the one or more flux augmentation rings are arranged at a substantially similar radial distance from the common axis;
an input source capable of transferring mechanical energy to the one or more rotors; and
an output load capable of receiving electrical energy from the one or more coils;
wherein the input source drives rotation of the one or more rotors, providing for magnetic fields spanning between the one or more magnets and the one or more flux augmentation rings to cross the one or more conductive coils, thereby generating electrical energy that is transferred to the output load.

21. The axial flux alternator of claim 20, wherein the one or more coils are connected in series for single-phase power takeoff

22. The axial flux alternator of claim 20, wherein subsets of the one or more coils are wired in series for multi-phase power takeoff.
